(19) United States
(12) Patent Application Publication
(10) Pub. No.: US 2007/0033908 A1
(43) Pub. Date: Feb. 15, 2007

(54) Crown piece assembly for an animal bridle and method

(76) Inventor: Peter Menet, Stein AR (CH)

Correspondence Address: John H. Miller, 22465 E. Alder Dr., Aurora, CO, 80016, US

(21) Appl. No.: 11/200,578

(22) Filed: Aug. 10, 2005

(51) Int. Cl. B68B 1/04

(52) U.S. Cl. 54/13

(57) ABSTRACT

A crown piece for an animal bridle comprises a soft, cushioned poll contacting portion that also comprises a strip of reinforcing and stabilizing material to produce a poll contacting portion that is more comfortable and more durable for horses, etc., while also being very effective in directing instructional forces to the animal's head. The strip of reinforcing and stabilizing material is any material that is strong, relatively non-elastic and durable when wet and can be a nylon webbing and many other materials. The strip of reinforcing and stabilizing material is isolated from the poll of the animal with a soft cover that can be calfskin or many other materials. A padding material can optionally be present inside the cover. A method of making the crown piece according to the invention is also disclosed.

The invention involves a crown piece assembly for use on all or most bridles used on animals such as a horse, pony, mule, etc. to provide instructive commands, and a method of making the crown piece according to the invention.

A bridle is used on a horse's head so the rider can control the horse. A bridle normally comprises reins, curb strap, bit, noseband, and headstall. The headstall includes a crownpiece comprising two or more straps that pass over the horses head or neck just behind the ears, the poll, as shown in FIG. 2 of U.S. Pat. No. 6,490,848 and FIG. 18 of U.S. Pat. No. 6,691,497. One strap connects to a headstall ring on a cheek piece of the bit and another strap attaches to the nose strap. A third strap forms a throatlatch, passing under the horse's throat to secure the bridal to the horse's head. This conventional arrangement can at times create unnecessary pressure and discomfort on the poll of the animal. The two or more straps working independently tend to pinch a horse's poll, cause undesirable pressure on the poll area and also, due to perspiration collecting under the leather straps, can cause sore spots on the horse's poll. On some crown pieces the two or more straps are designed to lay one on top of the other, however they are not fastened together and therefore tend to work apart and act as two separate straps.

It is known, as shown in U.S. Pat. No. 6,691,497, particularly FIGS. 23-32 to replace two or more straps of the crown piece that passes over and rests on the poll into a single, resilient strap, having elastic properties. This crown piece stretches when a force is applied to the crown piece and then reportedly returns to its original length when the force is reduced. It has been found that the elastic nature of such crown pieces presents new problems including a reduction in the amount of controlling force on the animal, low durability of the crown piece and excessive rubbing of the animal's skin due to the stretching and contracting of the elastic crown piece. This invention corrects the problems mentioned above, undue stress on the pressure points on the poll due to over tightening of the bridle, and rubbing caused by the instability of elastic, by providing comfort to the animal and excellent durability and life.

### SUMMARY

The invention is a crown piece assembly for a bridle for an animal, usually a horse or pony, but for any animal on which a bridle is used, the crown piece being of an assembly that presents a single, cushioned, and relatively stable, strap for contacting the poll of the animal, the single strap assembly being separated on each side of, and below, the animal's poll, into two or more separate straps. Typically the crownpiece separates at points that will be on each side of the horse's poll and a few inches below the poll into two separate straps, but the crown piece can separate into three, or even more, separate straps if desired.

The crown piece comprises a main strap, usually of leather, that is typically separated into two or more straps beyond a poll contacting portion, a strip of stabilizing and reinforcing material attached to the poll-contacting portion of the main strap and a cushioning layer attached to the main strap or the reinforcing and stabilizing strip on the face closest to the poll, the cushioning layer optionally comprising a padding material. The crown piece can also optionally contain one or more additional straps, at least a portion of each additional strap being located between the main strap and a cover of the cushioning layer in at least a portion of the length of the crown piece. Most typically, the cushioning layer and the stabilizing and reinforcing layer, and optional padding layer when used, is attached to the main strap with one or more lines of stitching, most typically running parallel or generally parallel to the long dimension of the main strap, but other ways of attaching including adhesive, staples, rivets, point stitches and cross stitching can be used alone or with the one or more lines of stitching. By generally parallel is meant running in the lengthwise direction of the main strap even if not exactly parallel to the edge of the crown piece.

The cushioned, poll-contacting portion of the crown piece of the invention is, because of the reinforcing and stabilizing strip, is relatively non-elastic and very strong. By relatively non-elastic is meant that the poll-contacting portion of the crown piece does not stretch and/or contract nearly as much as crown pieces where the poll contacting portion is made is leather or a resilient, elastic material when a tension force is present in the crown piece or when the crown piece becomes wet with rain or perspiration.

Optional padding can be provided between the main strap and the cushioning, poll contacting, cover. Typically, this cushioning member comprises a layer of soft leather or synthetic leather, or other durable material, sewn or adhered to the main strap of the crown piece. This layer of soft cover layer can be skived, most typically on the unexposed side, to reduce the thickness on the end portions if desired. When the crown piece assembly of the invention is secured together with one or more sewn stitches, the stitching typically runs parallel or generally parallel to the crown piece. This stitching, one row, or two or more rows, spaced apart, act as a path or paths for drying air to ventilate the crown piece in contact with the horse's poll.

Most typically, the layer of cushioning, poll contacting, material is wider than the main strap in the poll contacting portion and a second strap, normally leather, is added between the main strap and the cushioning layer. Instead of a soft leather for the cover, other materials can be used to cushion and ventilate the crown piece of the invention. These materials include all types of soft leathers, synthetic leathers and woven or nonwoven textiles, particularly where the fibers include synthetic polymer fibers.

The stabilizing and reinforcing layer typically is a woven or nonwoven mesh, web or fabric, most typically nylon or other material that provides strength and stability without a lot of bulk. Other mesh, web or fabric materials that could be used contain any synthetic polymer fiber, fine metal, non-corrosive wire material or mixtures of these. The reinforcing and stabilizing layer can also include some natural fibers like cotton or wool and/or inorganic fibers like glass or carbon fibers. The crown piece of the invention, when used in any bridal, assures no unnecessary pressure on the poll.

The invention also comprises a method of making a crown piece assembly wherein the crown piece is made as an assembly of parts such that only a single strap contacts the poll. This is accomplished by using a main strap as the base of a crown piece, and at the end of or a short distance beyond a poll contacting portion of the main strap, separating the main strap into two or more separate straps by slitting the end portion or portions of the main strap to form two or more straps on each side of the poll contacting portion. By a short distance is meant typically at least about 0.25 inches, more typically at about 0.35 inch and most typically about 0.45 inch. Holes can be punched into one or more of the separate straps, and/or the optional second strap, or a buckle can be attached to the end portion of one or more of the separate straps in a conventional manner and other conventional embossing, skiving, stitching or surface modifying steps can be included if desired. A strip of stabilizing and reinforcing material and a soft cover is fastened to the poll-contacting side of the poll-contacting portion of the main strap.

More typically the method also includes attaching a poll contacting, cushioning layer on the poll-contacting side of the main strap in at least the poll-contacting portion of the main strap, and most typically extending to or almost to, typically within one inch of the point where the main strap is separated into two or more separate straps. The cushioning layer is most typically sewn to the main strap, but can be attached by other suitable manners, such as with an adhesive or spaced rivets, staples, cross stitches, point stitching, or equivalent ways. Most typically, the layer of cushioning, poll contacting, material is wider than the main strap in the poll-contacting portion.

When the word “about” is used herein it is meant that the amount or condition it modifies can vary some beyond that stated so long as the advantages of the invention are realized. Practically, there is rarely the time or resources available to very precisely determine the limits of all the parameters of one's invention because to do so would require an effort far greater than can be justified at the time the invention is being developed to a commercial reality. The skilled artisan understands this and expects that the disclosed results of the invention might extend, at least somewhat, beyond one or more of the limits disclosed. Later, having the benefit of the inventors' disclosure and understanding the inventive concept and embodiments disclosed including the best mode known to the inventor, the inventor and others can, without inventive effort, explore beyond the limits disclosed to determine if the invention is realized beyond those limits and, when embodiments are found to be without any unexpected characteristics, those embodiments are within the meaning of the term “about” as used herein. It is not difficult for the artisan or others to determine whether such an embodiment is either as expected or, because of either a break in the continuity of results or one or more features that are significantly better than reported by the inventor, is surprising and thus an unobvious teaching leading to a further advance in the art.

### BRIEF DESCRIPTION OF DRAWINGS

FIG. 1 is a plan view of one embodiment of a prior art crown piece.

FIG. 1 A is a cross section of the poll contacting portion of the crown piece shown in FIG. 1, at lines 1A-1A.

FIG. 2 is a top view of a crown piece embodiment of the invention.

FIG. 3 is a front view of the crown piece shown in FIG. 2.

FIG. 4 is a bottom view of the crown piece shown in FIG. 2.

FIG. 5 is a cross section of the crown piece shown in FIG. 2, at lines 4-4.

FIG. 5A is a cross section of an embodiment that is a modification of the embodiment shown in FIGS. 2-4.

FIG. 6 is a top view of another cushioned crown piece made according to the invention.

FIG. 7 is a side view of the crown piece shown in FIG. 6.

FIG. 8 is a bottom view of the crown piece shown in FIGS. 6 and 7.

FIG. 9 is a partial, longitudinal, cross section of the crown piece shown in FIGS. 6-8 taken at lines 9-9.

FIG. 10 is a partial cross section of the crown piece shown in FIGS. 6-8 taken at lines 10-10.

### DETAILED DESCRIPTION

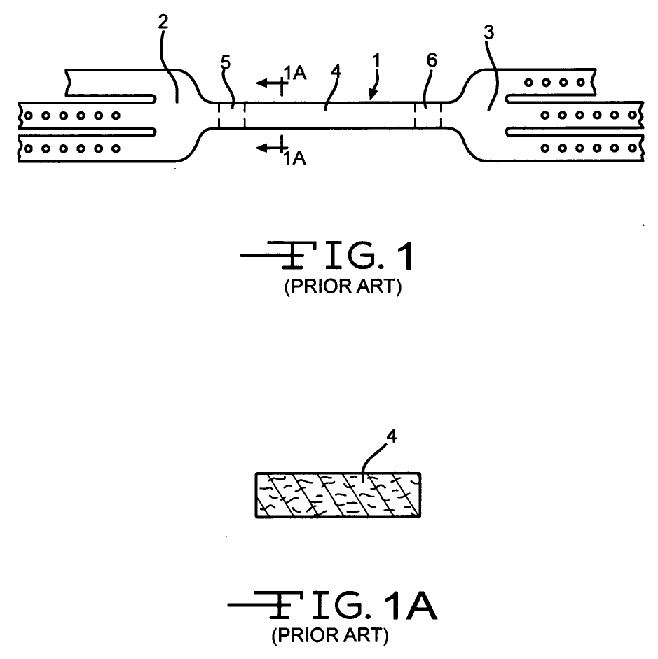

FIG. 1 shows a prior art crown piece 1 of the type shown in U.S. Pat. No. 6,691,497. This crown piece includes leather end pieces 2,3 on each side of a poll-contacting strip 4. This poll contacting strip 4 is shown in cross section in FIG. 1A, and is attached to the end pieces 2,3 by stitching overlaps 5,6. The '497 patent teaches using leather strap like material, rigid woven material or a resilient, elastic material as poll contacting strip 4. The ′497 patent teaches that the width of the poll contacting strip of the crown piece should provide a broad load-bearing surface across the horse's poll, apparently so that this strip does not rest on the edge of the bones behind the ears. It has been found that the front edge of the crown piece, the edge closest to the ears of the animal when the crown piece is in place as part of a bridle on the animal, if not cushioned, will irritate these bones, especially when the crown piece is applying strong instructive forces to the animal's head, or if the bridle is adjusted too tightly to the animals head. Also, the use of an elastic material for this strip reduces the instructive function of the crown piece and bridal and presents other undesirable results including rubbing due to stretching and contracting.

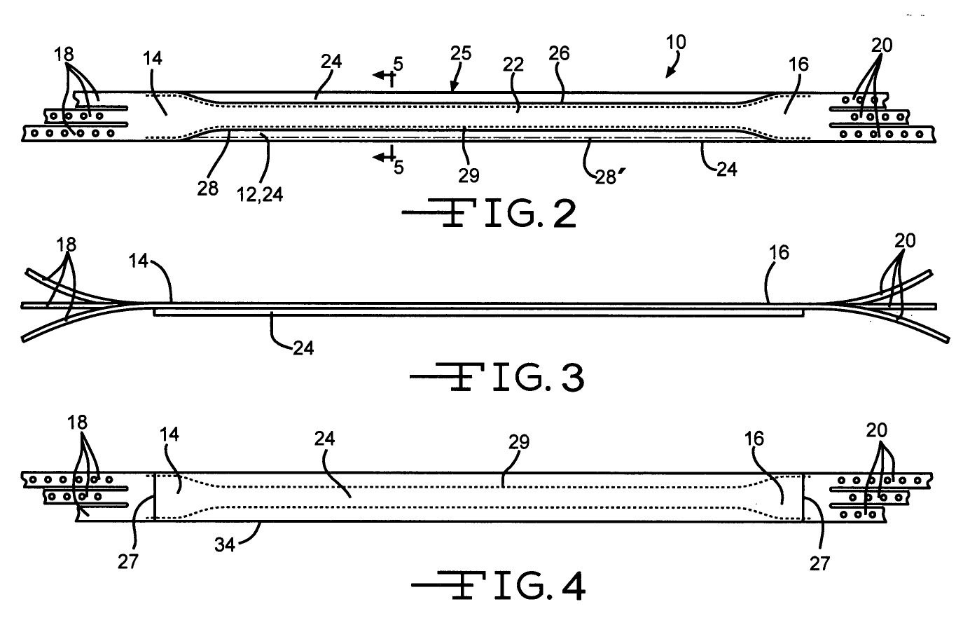

FIGS. 2-5 show one embodiment 10 of the crown piece assembly of the invention. The crown piece 10 contains a main strap 12 having end portions 14,16, each of which is slit to form two or more separate straps 18,20, these straps being for the nose band and other items of the head stall and bridle. The main strap 12 is typically leather such as cowhide, but can be woven or nonwoven textiles containing a strong fiber such as nylon, Kevlar, etc. A poll contacting portion 22 of the main strap 12, between the two end portions 14,16 is narrower than the end portions 14,16, to provide room for a cushion portion 24 that extends past, at least the front edge 26 of the main strap 12. A back edge 28 or 28′ of the poll contacting portion 22 of the main strap 12 can be even with a back edge of the two end portions 14,16 or can be narrowed to any desired degree, see 28 or 28′, that will provide adequate strength and support. The portion between the two end portions 14,16 is generally referred to as the cushioned poll-contacting portion 25, and the length is typically in a range about 9-13 inches for a riding horse, but the length can vary beyond this range depending on the size and type of the animal on which it will be used as part of a bridle. Not all of this length actually contacts the poll, but a substantial center portion of the length does contact the animal's poll.

The construction of the cushioned poll-contacting portion 25 of the crown piece 10 is shown in FIGS. 2-4 and 5A. The poll-contacting portion 25 of the crown piece assembly 10 is comprised of the narrowed portion 22 of the main strap 12, a stabilizing and reinforcing strip 30, a padding material 32 and a soft cover 34. For the main strap 22, leather, nylon, or any strong material or strong fabric can be used.

The ends 27 of the cover 34, between stitches 29, are unattached in this embodiment, but can be stitched or otherwise attached to the main strap end portions 14,16 if desired. In this embodiment, the reinforcing, stabilizing strip 30 material is a woven and or knitted nylon web, about 0.59 inch (1.5 cm, about 18 loop or warp fibers/inch and about 13-14 weft fibers/inch) to about one inch (2.5 cm) wide, depending on bridle model, and about 0.010-0.012 inch thick, but many other reinforcing materials, widths, thread or fiber counts, and thicknesses can be used.

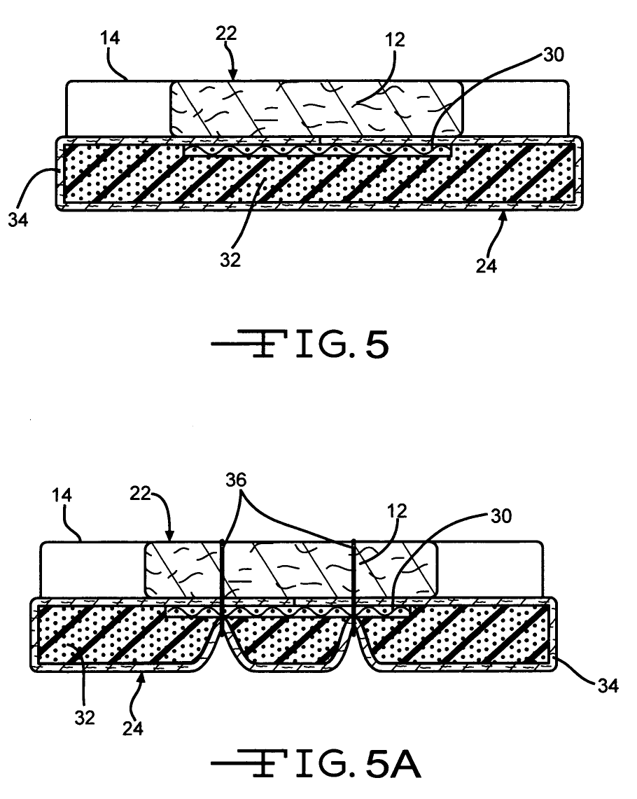

The crown piece assembly can be secured together with any suitable fastening techniques such as by sewing, riveting, stapling, adhesives or other equivalent materials. The embodiment shown in FIGS. 2-4, shows optional stitches 29 which are used most typically. FIG. 5 shows a cross section where adhesive is used to bond the different parts of the assembly together. Any adhesive that bonds strongly to leather and that is water resistant is suitable. In the assemblies shown by 5 and 5A, the reinforcing and stabilizing strip 30 can be located as shown, or can be located between the soft, leather, cover 34 and the main strap 12, most typically the latter alternative. FIG. 5A shows a cross section of embodiments of the cushioned poll-contacting portion 25 where continuous or point stitching or spaced rivets, staples or other mechanical fastening means 36 is used to secure the assembly together. These fastening means can penetrate the entire thickness, or only partially penetrate the thickness, of the main strap 12. An optional layer of padding 32 is contained within the cushion cover 34.

The furrows 31 formed in the cushion of the cushioned, poll-contacting, portion provide good ventilation for that part of the animal in contact with the crown piece assembly of the invention when the bridal is in use. In the embodiment shown in FIGS. 2-4, continuous stitching 29 is used to secure the assembly together. While FIGS. 5 and 5A show fairly square corners in the poll-contacting cushion 24, these corners can be, and typically are more rounded, particularly after some use of the crown piece assembly of the invention.

The reinforcing and stabilizing strip 30 provides resistance to stretching and also adds strength to the poll-contacting portion 25, and is at least as wide as about 0.25 inch, more typically is about 0.5 inch wide and can be up to as wide as the end portions 14,16, and most typically extends from one end portion 14 to the other end portion 16, but can be somewhat shorter so long as it extends over the length of the narrowest portion of the strap 22. It can also be longer, but there is no reason for that. In this embodiment, the reinforcing and stabilizing strip 30 is about 0.59 inches wide (1.5 cm) and extends from left to right for the complete length of the poll-contacting portion with a minimum length of about 13.4 inches (34 cm) to a maximum length of about 14.6 inches (37 cm) depending on size and model of a typical horse bridle.

In this embodiment, the padding 32 is most typically a layer of polymer foam, such as polypropylene, polyurethane or natural latex, readily available from various suppliers and about 1/16 to ⅛ inch thick, but the thickness is a matter of choice as also is the density of the foam. Most typically the padding should be able to breath, i. e. be air permeable and must be able to withstand getting wet without deteriorating. Tangled synthetic fiber padding could also be used.

In this embodiment the soft cushion cover 34 is a calfskin leather specially tanned and developed for use in bridles and is available from selected tanneries in England, France, or the United States, and is identified by the suppliers as high grade calfskin. Other types of soft leather can also be used and also various woven and nonwoven textiles and synthetic leathers including vinyl can be used as the cover 34. In this embodiment the cover 34 is about 0.018-0.02 inch thick, but the cover 34 can be thicker or thinner and end portions of the cover 34 can be skived down to make them thinner where they overlap and attach to the end portions 14,16 of the main strap 12 if desired.

To make the embodiment shown in FIGS. 2-5A, the following sequential steps are performed:
Step 1—Cut out shape for main strap.
Step 2—Cut a strip of reinforcing and stabilizing material to an appropriate length and optionally glue it to the underneath side of a narrow portion of the main strap.
Step 3—Cut a soft cover material 34 to appropriate size and optionally attach a layer of padding 32 to the inside of the cover with an appropriate adhesive for the two materials. The width of the layer of padding 32 can be as wide as the cover, but more typically is only as wide as the flat part of the cover that will contact the animal, i. e. is not folded when the cover is folded over around the padding.
Step 5—Fold the soft cover 34 bringing the two longitudinal edges together or nearly together using an adhesive suitable for the two materials to hold the parts together.
Step 6—Assemble the folded padding cushion with the main strap and reinforcing and stabilizing strip 30, spanning the joint between the two longitudinal edges of the soft cover 34 with the strip of reinforcing and stabilizing material 30.
Step 7—Fasten the parts together using any suitable means, such as with an adhesive as shown in FIG. 5 or by sewing stitches 29 as shown in FIGS. 2 and 4 or with spaced apart fasteners 36, all as shown in FIG. 5A.

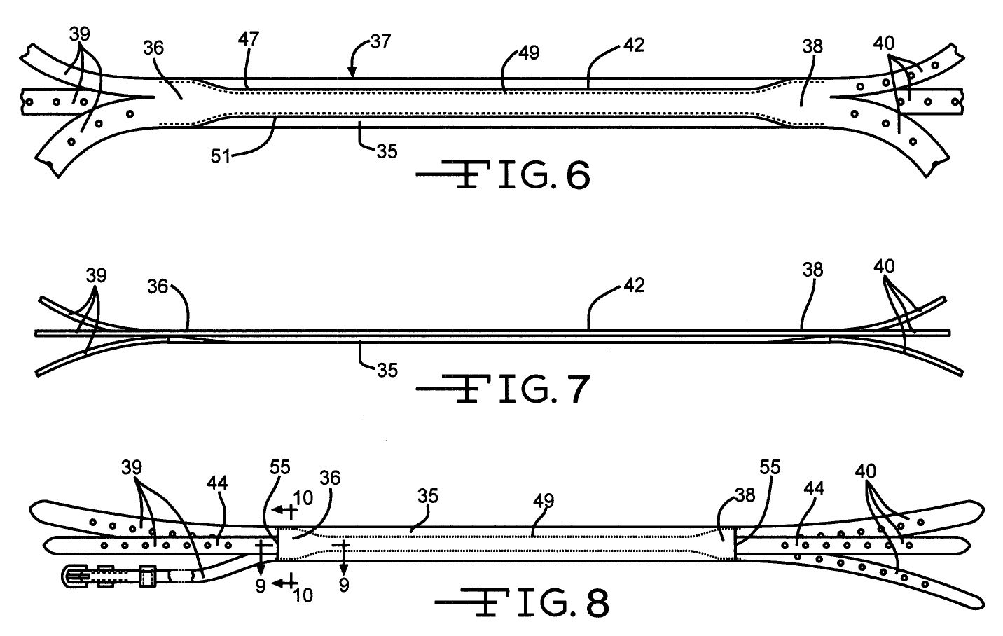

FIGS. 6-10 show another and most typical embodiment of the crown piece assembly of the invention. This crown piece assembly contains a main strap 42 having end portions 36,38, each of which is slit to form two or more separate straps 39,40, these straps being for the nose band and other items of the head stall and bridal. A poll contacting portion 37 of the main strap 42, between the two end portions 36,38 is narrower than the end portions 36,38, to provide room for a cushion portion 35 that extends past, at least the front edge 47 of the main strap 42. A back edge 51 of the poll contacting portion 37 of the main strap 42 can be even with a back edge of the two end portions 36,38 or can be narrowed to any desired degree, see 28 or 28′ of FIG. 2, that will provide adequate strength and support. The portion between the two end portions 36,38 is generally referred to as the cushioned poll-contacting portion 37, and the length is typically in a range about 9-13 inches for a riding horse, but the length can vary beyond this range depending on the size and type of the animal.

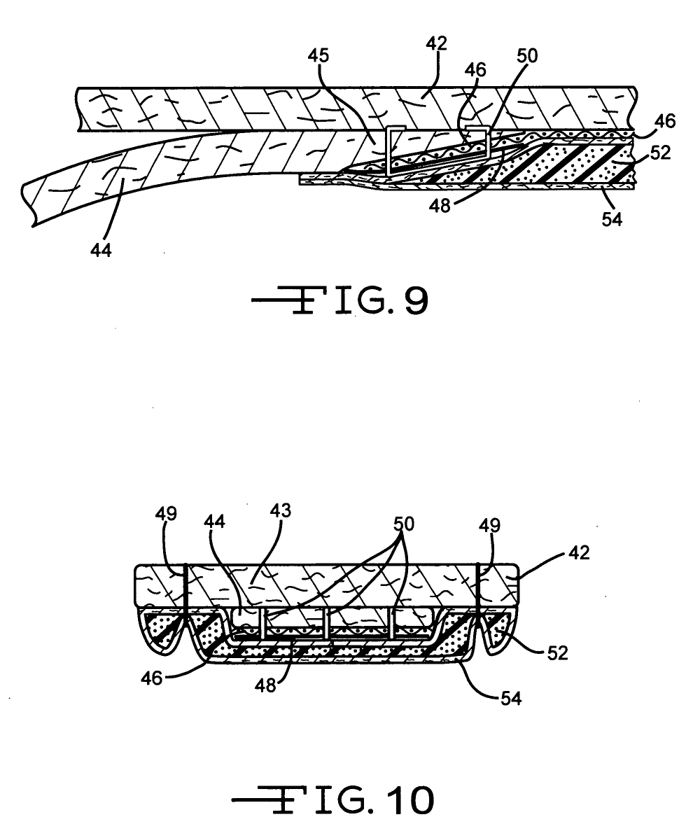

In this embodiment, another strap 44, in this embodiment the center strap, is not continuous, but instead is a short piece of strapping 44 attached to the main strap 42 at each of the end portions 36,38 as shown in detail in FIG. 9, a partial longitudinal cross section along lines 9-9 in FIG. 8. This also represents the construction at the other end portion 38. An unexposed end of the additional strap 44 is skived down, tapered down in thickness, and secured to the end portion 14 of the main strap 42 with one or more staples 50. The length of the tapered end of the straps 44 in this embodiment is about 1.25 inch, but this length can be more or less than this depending on the anticipated stress on this strap 44.

Prior to stapling the strip of stabilizing and reinforcing material 46, most typically, but not necessarily, having the same width as the strap 44, to the tapered portion of strap 44 to provide added holding strength for the staples, rivets, etc. and the strap 44, an optional layer of thin, strong basting tape 48 is attached to the back side of the end portion of the strip 46. In this embodiment, the basting tape 48 is about 1.5 inches long, about 0.5-0.57 inches wide and about 0.009-0.01 inches thick, but these dimensions are not critical to the invention as long as the disclosed function of the crown piece are met. Any strong basting tape, preferably of a synthetic polymer, can be used when it is desired to use basting tape in the crown piece of the invention. The reinforcing and stabilizing material 46 is the same as used in the embodiment of FIGS. 2-5A, and the other materials mentioned above as useful as a reinforcement and stabilizing material can also be used in this embodiment of FIGS. 6-10.

Attaching additional straps 44 in the manner shown in FIGS. 6-10, instead of making it part of the main strap 42 permits locating the additional strap 44 in a more optimum position for its function as a throat latch or other part of a bridal. Making the strap 44 in the manner disclosed above, i. e. in two pieces attached to the reinforcing and stabilizing strap 46 and to the assembly 37 also produces a thinner, more comfortable poll-contacting portion on the crown piece.

The construction of the cushioned poll-contacting portion 37 of the crown piece assembly is shown in more detail in FIGS. 9 and 10. The poll-contacting portion 37 of the crown piece assembly is comprised of the narrowed portion 43 of the main strap 42, a stabilizing and reinforcing strip 46, a padding material 52 and a soft cover 54. Unattached ends of the cover 54, between stitches 49, are shown as ends 55.

This crown piece assembly is secured together by sewing the parts together with two spaced apart stitches 49, but, although not as desirable, other means of securement can be used as described above with the embodiments of FIGS. 2-5A, such as with adhesives, spaced rivets, staples or other mechanical fastening means to secure the assembly together. The mechanical fastening means can penetrate the entire thickness, or only partially penetrate the thickness, of the main strap 42. In this embodiment a furrow is formed in the cushion with each continuous stitching 49 that provides ventilation for that part of the animal in contact with the crown piece assembly when part of a bridal in use. While FIG. 10 shows fairly square corners in the poll-contacting cushion portion 37, these corners can be, and typically are, more rounded, particularly after some use of the crown piece assembly of the invention.

The reinforcing and stabilizing strip 46 provides preventive resistance to stretching of the poll-contacting portion 37 and also adds strength to the poll-contacting portion 37 and to the straps 44. It is typically at least as wide as discussed above for reinforcing and stabilizing strip 30 and extends over the length of the narrowed portion of the main strap 42 and over at least about 0.25 inch, more typically at least about 0.5 inch, most typically at least about 0.75 inch and up to 1.25 inches or more of the end portion of the straps 44, most typically tapered end portions on straps 44. In this embodiment, the reinforcing and stabilizing strip 46 extends over the tapered end portions of the straps 44 a distance of about 1.25 inch.

In this embodiment, the padding 52 is also optional and is the same as that disclosed above as optional in the embodiment of FIGS. 2-5A. The alternative materials disclosed above as useful as padding 52 are also useable in this embodiment. The thickness of the layer of uncompressed padding 52 in this embodiment is the same as described in the embodiment shown in FIGS. 2-5A, but can be thicker or thinner as desired

In this embodiment the cushion cover 54 is the same as disclosed for use in the embodiment of FIGS. 2-5A. Other materials that can be used as the soft cover 54 include the same alternative materials disclosed above for the embodiment of FIGS. 2-5A. The thickness of the cover 54 is also the same as disclosed for the embodiment of FIGS. 2-5A.

Materials other than those described above can be used in the crown piece assembly of the invention for the main strap, the reinforcing, stabilizing strip, the padding and the soft cushion cover. For the main strap, and additional straps, leather, nylon, or any strong material or fabric can be used. These include, but are not limited to polyurethane, polypropylene, polyamide, and other strong stitchable webs, synthetic leathers including Bicast™, Skai™, Lorica™, and other suitable soft hide leathers e.g. goat, sheep deer, moose, etc.

FIGS. 5, 5A and 10 show the two unexposed edges of the soft cover coming together under the main strap 12 and 42 prior to securing the parts of the cushioned crown piece assembly together, but this is not necessary. A gap of reasonable width can exist between the longitudinal edges of the cover 34,54, or, although not desired, can overlap a reasonable amount.

The crown piece assembly of the invention can be used in many types of bridals by varying the size, number of straps, the design of the ends of the straps and other conventional modifications and with other conventional parts as will be well known to those with ordinary skill in making bridals. Also, the wider end portions 14,16 and 36,38 of the crown piece assembly embodiments shown in the drawings are shaped to receive a loop that is on each end of a forehead strap, not part of the invention, but part of animal bridles.

Different embodiments employing the concept and teachings of the invention will be apparent and obvious to those of ordinary skill in this art and these embodiments are likewise intended to be within the scope of the claims. The inventor does not intend to abandon any disclosed inventions that are reasonably disclosed but do not appear to be literally claimed below, but rather intends those embodiments to be included in the broad claims either literally or as equivalents to the embodiments that are literally included.

1. A crown piece assembly for a bridle comprising a main strap having two end portions and a cushioned, poll-contacting portion, the cushioned poll-contacting portion of the assembly also comprises a strip of reinforcing and stabilizing material and a soft cover for the strip of reinforcing and stabilizing strip, both attached to the main strap.

2. The crown piece assembly of claim 1 wherein the poll contacting portion extends between the two end portions of the crown piece.

3. The crown piece assembly of claim 1 wherein the strip of reinforcing and stabilizing material is adjacent to an unexposed surface of the main strap.

4. The crown piece assembly of claim 2 wherein the strip of reinforcing and stabilizing material is adjacent to an unexposed surface of the main strap.

5. The crown piece assembly of claim 1 wherein the poll-contacting portion also comprises one or more layers of a padding material.

6. The crown piece assembly of claim 2 wherein the poll-contacting portion also comprises one or more layers of a padding material.

7. The crown piece assembly of claim 3 wherein the poll-contacting portion also comprises one or more layers of a padding material.

8. The crown piece assembly of claim 4 wherein the poll-contacting portion also comprises one or more layers of a padding material.

9. The crown piece assembly of claim 1 wherein the strip of reinforcing and stabilizing material is nylon.

10. The crown piece assembly of claim 2 wherein the strip of reinforcing and stabilizing material is nylon.

11. The crown piece assembly of claim 3 wherein the strip of reinforcing and stabilizing material is nylon.

12. The crown piece assembly of claim 4 wherein the strip of reinforcing and stabilizing material is nylon.

13. The crown piece assembly of claim 5 wherein the strip of reinforcing and stabilizing material is nylon.

14. The crown piece assembly of claim 7 wherein the strip of reinforcing and stabilizing material is nylon.

15. The crown piece assembly of claim 1 wherein the different parts of the assembly are secured together by sewing.

16. The crown piece assembly of claim 2 wherein the different parts of the assembly are secured together by sewing.

17. The crown piece assembly of claim 3 wherein the different parts of the assembly are secured together by sewing.

18. The crown piece assembly of claim 14 wherein the different parts of the assembly are secured together by sewing.

19. A crown piece assembly for a bridle comprising a main strap having two end portions and a cushioned, poll-contacting portion, the cushioned poll-contacting portion of the assembly comprising two end portions of other straps, a strip of reinforcing and stabilizing material overlapping the two end portions of the other straps, a layer of adhesive tape covering one face of two end portions of the reinforcing and stabilizing strip, each end portion of the other straps, the overlapping end portion of the reinforcing and stabilizing strip and at least a portion of the length of the adhesive tape being secured together with one or more fasteners, the poll-contacting portion also containing one or more layers of a padding inside a soft cover for the strip of reinforcing and stabilizing strip, all these parts of the assembly being attached to the main strap by stitches, the layer of reinforcing and stabilizing material being a strong, stable webbing material.

20. A method of making a crown piece for a bridle comprising the steps of:
a)—cut out shape for main strap,
b)—cut a strip of reinforcing and stabilizing material to an appropriate length and optionally glue it to the underneath side of a narrow portion of the main strap or inside a soft cover,
c)—cut the soft cover material to appropriate size and optionally attach a layer of padding 32 to the inside of the cover with an appropriate adhesive for the two materials
d)—fold the soft cover bringing the two longitudinal edges together or nearly together using an adhesive suitable for the two materials to hold the parts together.
e)—assemble the folded padding cushion with the main strap and reinforcing and stabilizing strip, spanning the joint between the two longitudinal edges of the soft cover with the strip of reinforcing and stabilizing material, and
f)—fasten the parts together.
